(19) United States
(12) Patent Application Publication
(10) Pub. No.: US 2023/0093493 A1
(43) Pub. Date: Mar. 23, 2023

(54) Apparatus, Device, Method, and Computer Program for Configuring a Processing Device

(71) Applicant: Intel Corporation, Santa Clara, CA (US)

(72) Inventors: Rajesh POORNACHANDRAN, Portland, OR (US); Kshitij Arun DOSHI, Tempe, AZ (US); Vinayak HONKOTE, Bangalore (IN); Vincent ZIMMER, Issaquah, WA (US); Subrata BANIK, Bangalore (IN)

(21) Appl. No.: 17/936,861

(22) Filed: Sep. 30, 2022

(51) Int. Cl. G06F 11/07

(52) U.S. Cl. CPC G06F 11/0772; G06F 11/0793; G06F 11/079

(57) ABSTRACT

Examples of the present disclosure relate to an apparatus, device, method, and computer program for configuring a processing device, and to a computer system comprising such an apparatus or device. The apparatus or device is configured to obtain information on a failure related to a component of the processing device, with the failure having occurred at runtime of the processing device, determine information on a microcode update to be applied to the processing device to remedy the failure related to the component, and configure the processing device to apply the microcode update.

### BACKGROUND

Improving the quality of hardware platforms, e.g., by reducing a Defect Per Million (DPM) is a key imperative for hardware vendors and manufacturers, in particular in contexts where first-party and third-party IP (Intellectual Property) blocks are used.

For example, projects, such as Intel's Flight Safety Evidence Package for functional safety, provide an example on how manufacturers have been helping aerospace suppliers towards achieving their safety certification via processor artifacts to support DO-254 certification up to design assurance level (DAL). The goal of such projects is to gain insights on how shared resources in a multi-core package work to derive determinism (which is a major aspect in functional safety).

In many computer systems, hardware errors are propagated as non-maskable interrupts (NMIs) or catastrophic machine check/array freeze events, causing failover or hard halts that are not acceptable for safety critical autonomous systems. Such behavior may affect system uptime, and lead to an increased DPM, reduced safety, reduced reliability and/or increased TCO. Generally, such hardware behavior also might provide no basis for evaluating and evolving the ISA (Instruction Set Architecture) towards improving the silicon health and DPM metric.

While previous work has been aimed at providing fine granular telemetry on the potential latency, contention, starvation on the shared resources, it generally does not provide the capabilities to support self-healing or graceful failure handling in field.

### BRIEF DESCRIPTION OF THE FIGURES

Some examples of apparatuses and/or methods will be described in the following by way of example only, and with reference to the accompanying figures, in which

FIG. 1a shows a block diagram of an example of an apparatus or device for configuring a processing device, and of a computer system comprising such an apparatus or device;

FIG. 1b shows a flow chart of an example of a method for configuring a processing device;

FIG. 1c shows a schematic diagram of a processing device;

FIG. 2 shows a schematic diagram of an example of a system architecture of an In-Field-Scan extended microcode (XuCode) handler (IFSXu);

FIG. 3 shows an example of the configurational flow across components of the proposed concept; and

FIG. 4 shows an example of an operational flow of the IFSXu.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

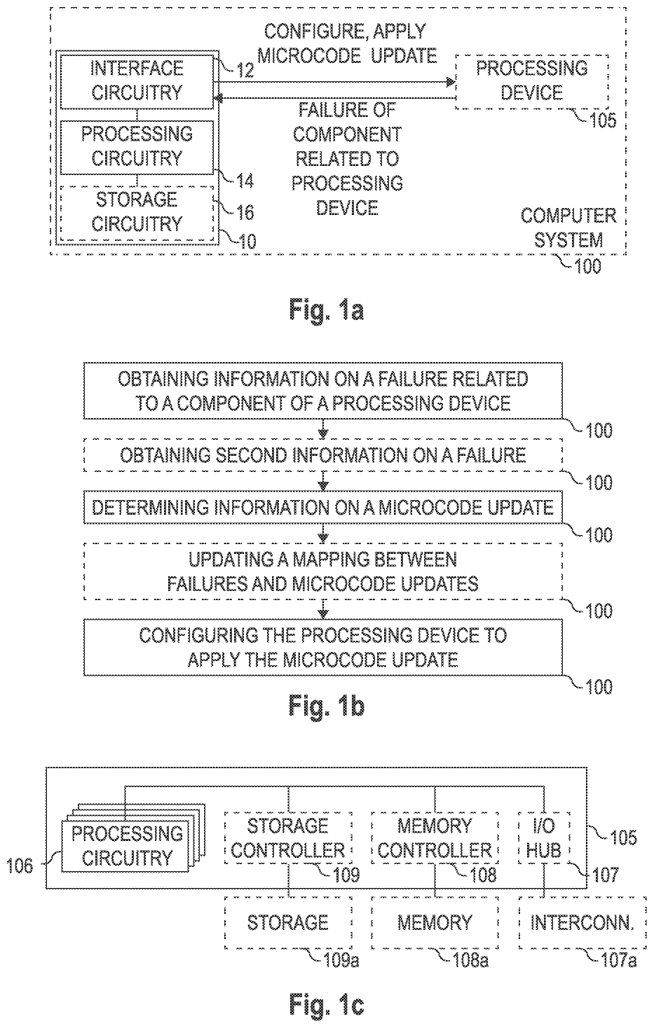

FIG. 1a shows a block diagram of an example of an apparatus 10 or device 10 for configuring a processing device 105. The apparatus 10 comprises circuitry that is configured to provide the functionality of the apparatus 10. For example, the apparatus 10 of FIGS. 1a and 1b comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may be configured to provide the functionality of the apparatus, in conjunction with the interface circuitry 12 (for exchanging information, e.g., with other components inside or outside a computer system 100 comprising the apparatus or device 10, such as the processing device 105 or a server of an operator of the computer system 100) and the storage circuitry (for storing information, such as machine-readable instructions) 16. Likewise, the device 10 may comprise means that is/are configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is configured to obtain information on a failure related to a component of the processing device 105, with the failure having occurred at runtime of the processing device. The processing circuitry 14 or means for processing 14 is configured to determine information on a microcode update to be applied to the processing device to remedy the failure related to the component. The processing circuitry 14 or means for processing 14 is configured to configure the processing device to apply the microcode update.

FIG. 1a further shows the computer system 100 comprising the apparatus 10 or device 10 and the processing device 105. For example, the apparatus 10 or device 10 may be implemented as part of a system firmware (e.g., Unified Extensible Firmware Interface, UEFI, or Basic Input/Output System, BIOS) of the computer system 100. In other words, the functionality described herein may be implemented as part of the system firmware, e.g., without requiring support from an operating system or virtual machine-manager being executed on the computer system.

FIG. 1b shows a flow chart of an example of a corresponding method for configuring a processing device. The method comprises obtaining 110 the information on the failure related to a component of the processing device 105. The method comprises determining 130 the information on the microcode update to be applied to the processing device to remedy the failure related to the component. The method comprises configuring 140 the processing device to apply the microcode update. For example, the computer system 100 (e.g., the apparatus 10 or device 10 of the computer system 100) may be configured to perform the method. In particular, the method may be performed by the system firmware of the computer system.

In the following, the functionality of the apparatus 10, the device 10, the method and of a corresponding computer program is illustrated with respect to the apparatus 10. Features introduced in connection with the apparatus 10 may likewise be included in the corresponding device 10, method and computer program.

Various examples of the proposed concept are based on the finding, that, while there are mechanisms for detecting failures of hardware components of a computer system, such as Intel® In-Field Scan (IFS), such failures often cannot be remedied automatically, as the failures are permanent and are thus likely to occur on a regular basis. In the proposed concept, a handler is proposed for remedying hardware failures that have occurred at runtime of a processing device. This handler uses microcode updates to configure the processing device, in order to implement a work-around to avoid causing the failure, or to deactivate a component of the processing device, so that the processing devices can continue to be (mostly) used despite a failure being detected. This may improve the reliability of the processing device and avoid fatal crashes of the computer system, which may improve the Total Cost of Ownership of the computer system. Moreover, more permanent remedies, such as a more permanent patch for remedying the failure or replacement of the processing device, may be scheduled for a maintenance window, instead of requiring instant attention from a service technician, which may reduce the effort of an operator running the computer system.

In the following, many examples will be presented where the processing device is a Central Processing Unit (CPU) of the computer system. However, the proposed concept may be applied to any type of processing device that supports microcode updates, i.e., that supports modification of the behavior of the processing device through application of a microcode/firmware update. Accordingly, the processing device may be an XPU (X Processing Unit, with X being used to indicate various types processing units). For example, the XPU may be one of a Central Processing Unit (CPU), Graphics Processing Unit (GPU), an Artificial Intelligence (AI) accelerator, an accelerator card (such as a cryptocurrency mining accelerator) and offloading circuitry.

Depending on the processing device being used, the component of the processing device, to which the failure relates may be different, too. For example, if the processing device is a CPU, the component may be a processing circuit of the CPU, such as an ALU (Arithmetic Logic Unit), a memory, such as a register, a cache, a bus, or a controller (such as an Input/Output (I/O) controller, a memory controller, or a storage controller) that is part of the CPU. In the latter case, the CPU may also be considered a System-on-Chip (SoC), having one or more controllers integrated in the CPU. Similarly, if the processing device is a GPU, AI accelerator, accelerator card or offloading circuitry, the component may be a processing circuit, such as an execution unit, a memory, a register, a cache, a bus, or a controller (such as an I/O controller or a memory controller) of the processing device. In the present disclosure, failures are being remedied that relate to the respective component of the processing device. Therefore, in many cases, the respective failure may occur in the component of the processing device. However, as will become evident in the following, in some cases, the failures may occur outside the processing device, e.g., in a memory, in a storage circuitry, or while communicating via an interface. In this case, the processing device may be used to remedy failures occurring outside the processing device.

In various examples, the process starts with the processing circuitry obtaining (e.g., receiving, being notified of) the information on the failure related to the component of the processing device 105. In general, there are various potential sources of the information on the failure. For example, the processing device (or the component thereof) may detect a failure occurring (a failure occurring within the component, or a failure occurring outside the component and having an effect on the component) and notify the processing circuitry of the failure having occurred. For example, the processing circuitry may be configured to handle a non-maskable interrupt (NMI) being raised by the processing device (or the component thereof), with the NMI comprising the information on the failure (or an address of memory comprising the information on the failure). Alternatively, an in-field hardware scanning mechanism, such as the aforementioned Intel® In-Field Scan may be used to provide the information on the failure to the processing circuitry. In other words, the processing circuitry may be configured to obtain the information on the failure related to the component of the processing device from an in-field scan circuitry of the processing device. Accordingly, as shown in FIG. 1b, the method may comprise obtaining 110 the information on the failure related to the component of the processing device from an in-field scan circuitry of the processing device. As a result, the information on the failure related to the component may be based on a failure related to the component occurring in the field (i.e., after manufacturing, during runtime of the processing device (at the customer)). The in-field scan circuitry may scan the hardware of the processing device for errors/failures and report them as information on the failure to the processing circuitry. For example, the in-field scan circuitry may raise an interrupt to notify the processing circuitry about the information on the failure. In other words, the processing circuitry may be configured to obtain the information on the failure related to the component after an interrupt being raised (e.g., in response to an interrupt being raised, by handling the interrupt) by the in-field scan circuitry of the processing device. Accordingly, as shown in FIG. 1b, the method may comprise obtaining 110 the information on the failure related to the component after an interrupt being raised by an in-field scan circuitry of the processing device. In both cases, the information on the failure may be obtained by providing an interrupt handler for handling interrupts related to hardware failures. In other words, the processing circuitry may be configured to provide an interrupt handler (for receiving/handling the information on the failure). However, other means of obtaining such information may be used as well. For example, the processing circuitry may be configured to read out the information on the failure from a register or memory region being used to log hardware failures. Alternatively, the processing circuitry may be configured to provide an Application Programming Interface (API) for receiving the information on the failure.

In most other systems, failure detection and remediation in processing devices is limited to the manufacturing process (where binning is used to sort processing devices according to their capabilities) or to scenarios, where customer-specific microcode updates are rolled out, after a formal and usually month-long fixing process, to the processing devices of a fleet of computer systems comprising the respective device (with the processing devices being taken offline between identification of the failure and application of the fixes). In contrast to these approaches, the proposed concept is an in-field process (i.e., after the manufacturing process, while the respective processing devices are being used by the customers) which does not require taking the respective computer systems offline. Instead, the failures may be remedied during the runtime of the respective processing devices, by dynamically applying microcode updates to the processing device.

For this purpose, the information on the failure is processed, by the processing circuitry, to determine the type of failure having occurred, and the component of the processing device being affected. For example, e.g., if the failure occurs within the processing device, the information on the failure related to the component may comprise information on a circuit-level failure affecting the component. If the failure occurs outside the processing device, the information on the failure related to the component may comprise details on how the component is being affected (e.g., information on hardware, such as memory, storage circuitry or an interconnect being controlled by the respective controller of the processing device). Using such information, the processing circuitry may select the remedy to apply.

In various examples of the proposed concept, the determination of the microcode update to apply, may be based on a mapping between failures and microcode updates to perform. In other words, the processing circuitry may be configured to determine the information on the microcode update to be applied to the processing device to remedy the failure related to the component based on a mapping between failures and microcode updates. Accordingly, as shown in FIG. 1b, the method may comprise determining 130 the information on the microcode update to be applied to the processing device to remedy the failure related to the component based on a mapping between failures and microcode updates. For example, the storage circuitry 16 may comprise the mapping, e.g., as a look-up table or database. The processing circuitry may be configured to identify or categorize the failure and select the corresponding microcode update based on the mapping.

In many scenarios, failures of hardware devices may occur over time, as aging effects affect the performance of the respective circuitry, in particular for circuitry being used constantly. Moreover, some failures occur when multiple different components are used concurrently or when other conditions are met, such as the use of Simultaneous Multithreading (SMT). In effect, remedies to such failures may not be known at shipping of the computer system, as the failures themselves are unknown to the manufacturer of the computer system. Therefore, the aforementioned mapping may be updated and/or extended over time, to account for newly discovered types of failures for which remedies have been designed over the lifetime of the processing device. For example, the processing circuitry may be configured to update the mapping between the failures and microcode updates. Accordingly, as further shown in FIG. 1b, the method may comprise updating 135 the mapping between the failures and microcode updates.

In the previous examples, the mapping between the failures and the microcode updates has been said to be provided by the manufacturer of the processing device. However, in some cases, different remedies may be available to remedy a failure. For example, a choice may be made between removing support for a part of the ISA and emulating this part of the ISA. Furthermore, a choice may be made between lowering an operating frequency of a component and excluding the component from concurrent use due to SMT. While these choices may be made by the manufacturer, in many scenarios, they may also be made by an operator of the respective computer system (i.e., the company using the computer system, which may be a Customer Service Provider, CSP). Accordingly, the mapping may be an operator-defined policy supplied by an operator of a computer system comprising the processing device. For example, the operator-defined policy may be applied to a fleet of computer systems being operated by the operator.

Once the microcode update has been selected, it may be applied to the processing device. In the following, two different types of microcode updates will be discussed, which may be used to enable different types of remedies.

In general, the microcode being run by a processing device determines at least some of the behavior of the processing device. For example, in CPUs, the control unit of the CPU is generally responsible for translating machine-code instructions defined by a computer program to circuit-level micro-operations (uOps). However, in case this translation proves, after shipping, to produce errors, some of the machine-code instructions can be handled via microcode, instead of being handled by the hard-coded (and therefore more efficient control unit). The functionality of the microcode-based translation is the same—the machine-code instructions are translated into corresponding micro-operations. However, the microcode can be updated after the respective processing device has been shipped, at runtime.

The proposed concept uses this microcode mechanism to remedy the detected failure. The processing circuitry is configured to configure the processing device to apply a microcode update that is suitable for remedying the failure that has been identified. For example, the microcode being run by the processing device may be extended to add one or more instructions (affecting the component) to be handled via microcode, with corresponding instructions on how the respective instruction(s) are to be handled (e.g., by emulating the instructions, or by using different circuitry). Alternatively, the microcode update may be configured to disable the component (e.g., by handling all instructions that relate to the component or by removing these instructions from the ISA). Accordingly, the microcode update may affect the instructions being exposed by the instruction set architecture of the processing device. In some cases, the use of the component may only be disabled in certain scenarios that are known to put a high strain on the respective component, such as SMT. Accordingly, the microcode update may affect a shared use of one or more components of the processing device in simultaneous multithreading. Alternatively, or additionally, the microcode update may change an operating frequency of the respective component. In other words, the microcode update may affect an operating frequency of the component of the processing device (e.g., via the Baseboard Management Controller). In this context, the term “microcode update” may refer to any update of the respective processing device that affects the configuration of the processing device, including operating frequencies and activation status of its components.

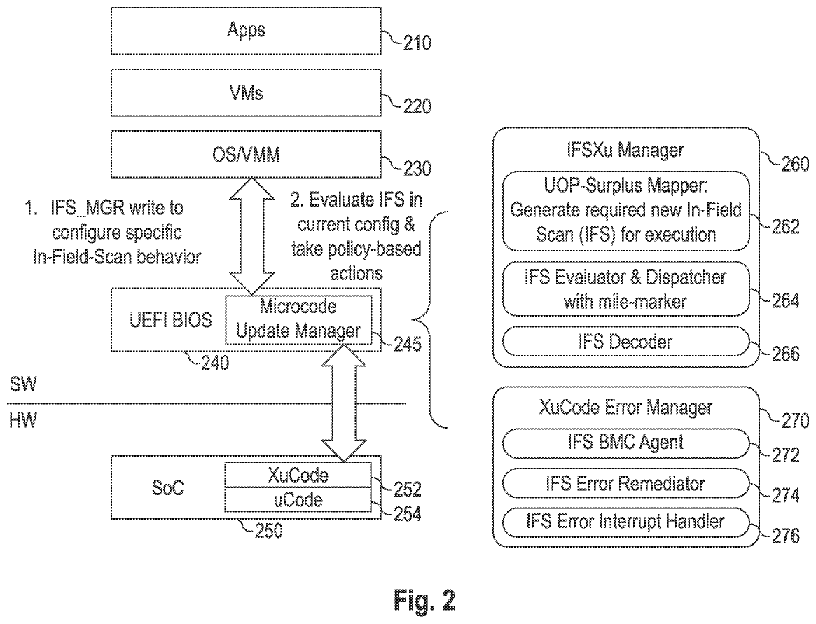

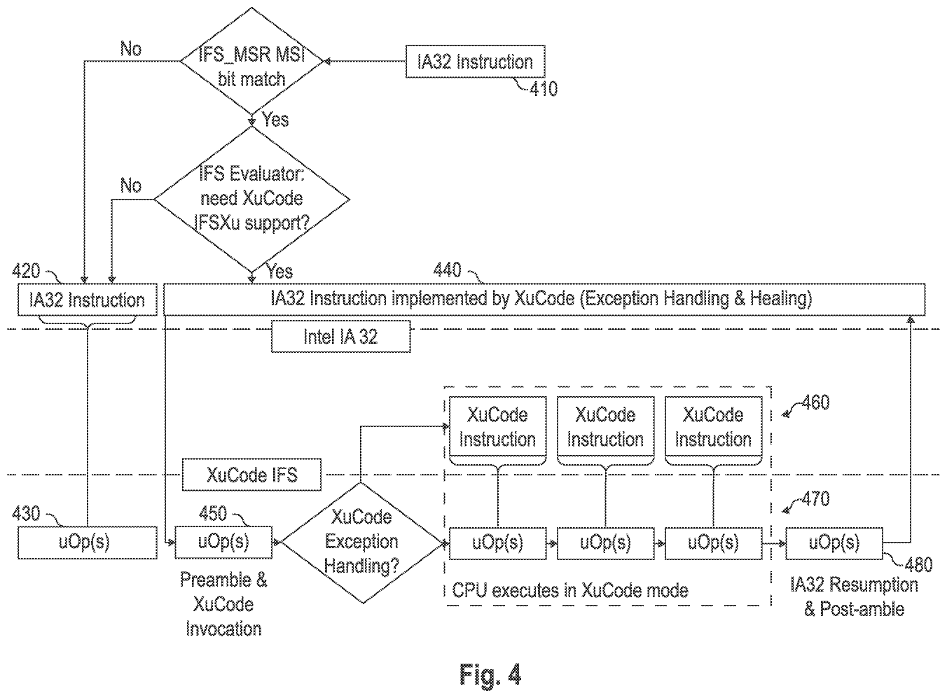

A main remedy being used in the proposed concept, however, seeks to avoid partially or entirely disabling the component, by specifying, by microcode, a workaround. Therefore, the microcode update may affect a use of one or more components of the processing device for performing an instruction being exposed by an instruction set architecture of the processing device. In particular, the microcode update may affect which components are used to handle the instruction being performed. For example, the microcode update may cause the component not to be used or to be used less frequently, by translating the machine-code such, that the resulting microoperations make less frequent use or no use of the component. Instead, the microcode update may define an emulation of the instruction being performed. In effect, the microcode update may comprise instructions to emulate a functionality originally provided by the component. In some cases, such an emulation may be achieved by just using another processing circuitry (e.g., ALU or execution unit) of the processing device. In some cases, however, emulation may be more complex. In this case, use of an extended microcode, such as Intel® XuCode, may be made. Accordingly, the microcode update may be or comprise a XuCode update. In connection with FIGS. 2 to 4, various examples are given on how XuCode can be used for this purpose. In particular, as shown in FIG. 4, XuCode may be used to handle instructions to be emulated, with the XuCode being used to generate the corresponding microinstructions 450 for invoking XuCode handling, microinstructions 470 for performing the XuCode instructions 460, and microinstructions 480 for resuming IA32 handling. Other instructions that do not require to be emulated, e.g., as they are not affected by the microcode update or as a simple microcode update suffices for these instructions, may bypass this XuCode handler. For example, the microcode update may enable and configure the XuCode handler.

As has been outlined before, in some cases, the failure may occur outside the processing device, but may nonetheless affect the component. In particular, the failure may occur in hardware components that are controlled by the processing device, such as a communication interconnect (such as Intel® Quick Path Interconnect, QPI, or Peripheral Component Interconnect express, PCIe), a memory (e.g., High Bandwidth Memory, HBM, on-package memory or a DIMM, Dual-Inline-Memory-Module) or storage circuitry (such as a solid-state drive). The processing device may comprise one or more controllers for controlling these hardware components. FIG. 1c shows a schematic diagram of a processing device, comprising processing circuitry 16, an (optional) I/O hub (for controlling the communication interconnect 107a), an (optional) memory controller 108 for controlling a memory 108a, and an (optional) storage controller 109 for controlling the storage circuitry 109a. These components may be configurable by microcode updates as well, such that machine-code instructions relating to the respective controller (or hardware device they represent) are handled by the microcode-based mechanism as well. For example, the microcode update may relate to an input/output controller 107 of the processing device, affecting the use of at least a part of an interface being coupled to the processing device. For example, if the information on the failure indicates, that a part of the interconnect, e.g., a PCIe lane, is correlated with a high bit error rate, the microcode update may be configured to operate the interconnect such, that the particular lane is not being used, e.g., by reconfiguring a PCIe x8 connection as PCIe x4 connection. In another example, the microcode update may relate to a memory controller 108 of the processing device, affecting the use of at least a portion of memory included in a computer system comprising the processing device. For example, a so-called device of the memory (of a DIMM) may be faulty, resulting in correctable or uncorrectable error. The microcode update may be configured to redirect memory instructions relating to the device such, that a spare device is used instead. Similarly, the microcode update may relate to a storage controller 109 of the processing device, affecting the use of at least a portion of storage circuitry included in a computer system comprising the processing device. For example, a portion of the storage circuitry may be faulty. The microcode update may be configured to redirect storage instructions relating to the faulty portion such, that spare storage capacity is used instead.

In the examples provided above, the microcode update is selected based on a failure that has occurred within this particular computer system, at runtime of the computer system. However, in some cases, an operator of a large fleet of similar machines may notice an occurrence of the same failure across the fleet, with the failure occurring in many but not all machines. As a preventive measures, microcode updates that remedy this failure may be applied to the fleet of machines, regardless of whether the failure has already occurred in the particular computer system. In other words, the processing circuitry may be configured to obtain second information on a failure of a component of the processing device occurring in other computer systems (being similar to the computer system 100 housing the apparatus 10). Accordingly, as shown in FIG. 1b, the method may comprise obtaining 120 second information on a failure of a component of the processing device occurring in other computer systems. For example, the second information may be operator-specified second information supplied by an operator of a computer system comprising the processing device, e.g., by the operator operating a fleet of similar computer systems. Accordingly, the second information may be based on failures of one or more components of the processing device having occurred in a plurality of (similar) computer systems (i.e., the fleet from computer systems) being operated by the operator. For example, the second information may be implemented similar to the information on the failure, indicating a failure that has occurred in the processing device of another computer system.

For example, the second information may be obtained (e.g., received, downloaded) from a server of the operator of the computer system (with the operator being separate from the manufacturer of the processing device and/or computer system). In general, the second information may be treated similar to the information on the failure. For example, the processing circuitry may be configured to determine information on a microcode update to be applied to the processing device to remedy the failure related to the component included in the second information, and to configure the processing device to apply the microcode update. Accordingly, the method may comprise determining 130 information on a microcode update to be applied to the processing device to remedy the failure related to the component included in the second information and configuring 140 the processing device to apply the microcode update. For example, the same mapping may be used to determine the information on the microcode update that is also used for the information on the failure.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a workstation computer system (e.g., a workstation computer system being used for scientific computation) or a server computer system, i.e., a computer system being used to serve functionality, such as the computer program, to one or client computers.

More details and aspects of the apparatus 10, device 10, method, computer program and computer system 100 are mentioned in connection with the proposed concept, or one or more examples described above or below (e.g., FIGS. 2 to 4). The apparatus 10, device 10, method, computer program and computer system 100 may comprise one or more additional optional features corresponding to one or more aspects of the proposed concept, or one or more examples described above or below.

Various examples of the present disclosure relate to a concept related to autonomous harvest (in the FuSA (Functional Safety) Domain). The proposed concept may provide a mechanism for an efficient CPU (Central Processing Unit) In-Field Scan (IFS), with the mechanism being suitable for remediating defects using microcode updates (e.g., using XuCode, in the following denoted IFSXu for this specific implementation) for improved reliability and safety.

Another aspect of the proposed concept relates to exposing the capability of In-Field-Scan (IFS) via XuCode for upcoming new ISAs (Instruction Set Architectures) or new exception handling capabilities. This may allow manufacturers and partners to evaluate new capabilities for joint co-engineering/research on how potential new techniques work in real-world deployment challenges including functionality, safety, security, and reliability.

FIG. 2 shows a schematic diagram of an example of a system architecture for IFSXu. On the left, FIG. 2 shows the layers “applications” 210, “virtual machines” (VMs) 220 and the Operating System (OS)/Virtual Machine Manager (VMM) 230, which may communicate with the system firmware (e.g., with the UEFI (Unified Extensible Firmware Interface) or BIOS (Basic Input/Output System)) 240. The system firmware may be extended with a microcode update manager 245, which may configure the XuCode 252 (an implementation of extended microcode) or microcode 254 of the SoC (System-on-Chip) 250. For example, the microcode update manager 245 may correspond to the apparatus 10 or device 10 shown in connection with FIG. 1a.

The microcode update manager 245 may comprise an IFSXu Manager 260 with an microoperation (uOp) surplus mapper 262, which may be used to generate a required new IFS for execution, an IFS Evaluator & Dispatcher 264 with a mile-marker and an IFS Decoder 266. The microcode update manager 245 may further comprise a XuCode Error Manager 270 with an IFS BMC (Baseboard Management Controller) Agent 262, an IFS Error Remediator 274, and an IFS Error Interrupt Handler 276.

For example, with respect to the SoC 250, the proposed IFSXu concept may involve exposure of IFS_MGR (In-Field Scan Manager) as an MSR (Manager Status Register) for the VMM/OS 230 to configure specific an ISA behavior (e.g., VNNI, Vector Neural Network Instruction). For example, Intel's extended microcode implementation XuCode provides the capability for the CPU to emulate specific ISA behavior. For example, based on the requirement/situation, a portion of the XuCode to be hardened and made proprietary—to mitigate any possibility of safety violations/exceptions. However, a portion of the XuCode can be extended for OEM (Original Equipment Manufacturers)/ISVs (Independent Software Vendors) to enable customizations as needed. This may also provide operators/customers to provide the flexibility to capture any exceptions for specific ISA behavior and complement existing in-field scan errors. These findings can be proliferated to improve the quality of the platform.

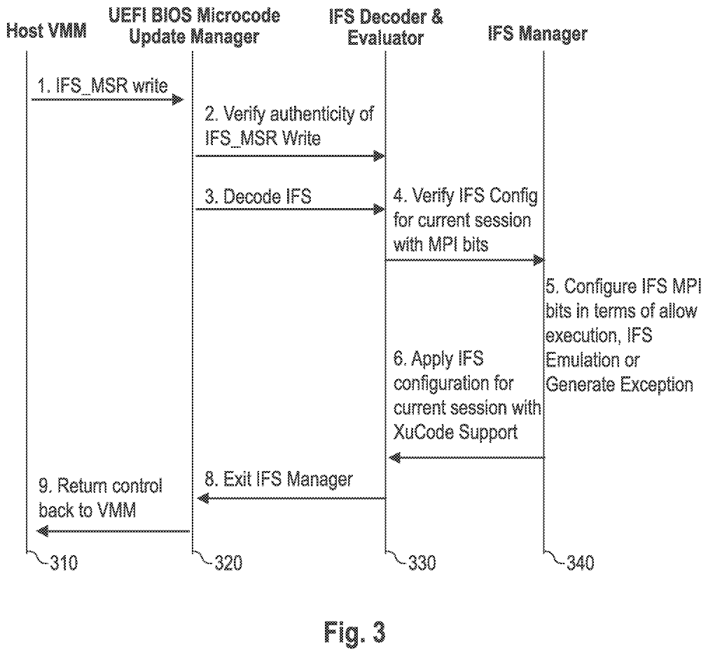

The microcode update manager 245 may be part of the system firmware (e.g., UEFI/BIOS) 240 and may handle the IFS Message Signaled Interrupts (IFS_MSI) generated by the IFS MSR trigger and handle the configuration flow shown in FIG. 3.

The Microcode IFS Manager 260 may handle most of the operational flow of IFSXU (FIG. 4), wherein it may evaluate the current IFS under consideration to be handled under following categories: (1) Direct pass-through mode, wherein IFS execution happens similar to today if allowed as per IFS_MGR MSI bits configured in configuration flow (as shown in FIG. 3), (2) IFS Emulation, wherein new IFS capabilities can be emulated via XuCode or Surplus uOps mapping (as shown in FIG. 4), or (3) IFS Trap/Exception Handling, wherein based on the MPI bit masks configured, execution may be prevented and a configurable policy based action may be taken, which may include generating an exception using XuCode. FIG. 3 shows an example of the configurational flow across components of the proposed concept highlighted in FIG. 2. FIG. 4 shows an example of an operational flow of the IFSXu 260.

In the following, an example of a configuration flow for the proposed concept is given, which is illustrated in FIG. 3. At 1., the host VMM (Virtual Machine Manager) 310 requiring a specific ISA prevention or emulation may request entry into the IFS Manager 340 by performing a write to the IFS Manager Status Register (IFS MSR), triggering the entry. At 2., the UEFI/BIOS Microcode Loader/Manager 320 may handle the IFS Message Signaled Interrupts (IFS_MSI) generated by the IFS MSR trigger. The UEFI BIOS Microcode Loader/Manager 320 may validate the following items: (a) IFS_MGR matches the CPU in the platform, (b) IFS_MGR has a valid Header, Loader version & checksum, and (c) IFS_MGR authenticity & signature check pass. At 3., based on the MSI bits set by host VMM 310, IFS_MGR 320 may decode and determine if the IFS should be allowed to execute, or should the IFS be emulated or generate an exception or block the IFS execution or take other configurable policy-based actions. At 4., the IFS Decoder & Evaluator 330 may verify the IFS configuration for the current session using the MPI (or MSI) bits. At 5., based on 4., MSI bits, the IFS_MGR 340 may take policy-based actions including generating new micro-Ops (and thus updating the microcode) using a surplus mapper for execution. Post configuration, the IFS_MGR may perform a host-MSR write to trigger unload of IFS_MGR Apps and IFS_MGR itself. At 6., the IFS_MGR may apply the IFS configuration for the current session with XuCode support. At 8., the flow may exit the IFS manager. At 9., the UEFI BIOS may return control back to host/VA/M.

FIG. 4 shows an example of the operational flow. Based on the configurational behavior for specific IFS under consideration, the IFSXu, which may be implemented by an aspect of the apparatus 10 or device 10 of FIG. 1a, may perform the following. When an IA32 (Intel® Architecture 32-bit) instruction 410 is called, the IFSXu may check whether the IA32 instructions has an IFS MSR MSI bit match (i.e., whether the IA32 instruction is part of a list of instructions for which a microcode update exists). If not, the IA32 instruction may be executed unmodified, or if the instruction is executed based on modified microcode, but does not require XuCode IFSXu support, the IA32 Instruction 420 is mapped directly to corresponding microoperation(s) 430 and executed. In other words, the IFSXu may perform direct pass-through of execution of IFS via the corresponding microoperations. If the IA32 has an IFS MSR MSI bit match and needs XuCode IFSXu support, the IA32 instruction 440 may be implemented using XuCode (for exception handling and healing). For example, if the if IFS needs to be trapped, IFSXu may go through XuCode appropriately to take the configured policy-based action via an interface to BMC (Baseboard Management Controller) where it may be remotely managed with appropriate telemetry/configurable policies. There, it may be translated into microoperations, including microoperation(s) 450 for preamble and XuCode invocation, microoperations 470 which are derived from XuCode instructions 460 (i.e., which implement the emulation), and microoperation(s) 480 for IA32 resumption and post-amble.

When signals from peripheral devices, such as PCI (Peripheral Component Interface) or PCIe (PCI express) signals arrive, the signals may be provided first to XuCode before sending an NMI/interrupt to the hypervisor OS, as XuCode may be used to remediate some class of issues (such as parity errors) to increase knowledge on errors seen by third-party telemetry. The DPM may be reduced by fixing things in the SoC (System-on-Chip), e.g., by issuing microcode updates that support the respective controllers. For example, Single bit error (SBE) from integrated HBM or other memories on the SOC can migrate memory mapping (using spare memory for sparing purposes) to increase the reliability.

The proposed concept may provide the capability to detect errors and recovery in-field (either full recovery or operate in degraded functionality), i.e., real-time resiliency in field at scale deployment in data center without off lining system. The proposed concept may reduce the Defect Per Million by reducing catastrophic errors in-field by letting operators use the system with desired or tolerable minimal functionality. The proposed concept may also support ISA uniformity (when deploying new kernels) for early evaluation on N−1 platforms. The proposed concept may also help in protecting critical portions with proprietary XuCode and also, provide flexibility with additional/extended portions for customers/OEMs to enable customizations. It may enable customers to trap and generate custom exception handling for specific ISA behavior programmable via MSR. It may provide the capability to allow the emulation of new ISA on N−1 CPUs (Central Processing Units) or to test waters for N+1 on current generation of SKUs. It may also enable the generation of additional stock keeping units, by socializing upcoming error handling for newer ISAs, future proof DPM with early fail-fast approach using N−1 gen.

Some implementations of the proposed concept may build upon the In-Field-Scan (IFS) capability supported by some Intel® Xeon® processors. IFS is a technique that can detect hardware failures by running tests. However, the initial implementation of IFS cannot remediate the failure. The proposed concept may combine IFS with remediation handlers. This may allow extending IFS to go beyond just detection and reporting flaws to the manufacturer but instead reduce the Total Cost of Ownership (TCO) by having the handlers ensure that the CPU can still operate for the customer (i.e., self-healing). Handlers can include, but are not limited, to Intel's extended microcode (XuCode), core microcode, SoC microcode, etc. In other systems, if IFS detects a bug or error, the IFS report is sent to the manufacturer and the CPU is taken offline. Then, the manufacturer develops (e.g., curates) a fix and creates a patch for patching the microcode, and delivers the patch to the customer, which applies the patch and brings the CPU back online.

In the proposed concept, if the IFS detects a bug or error, the IFS invokes the remediation handler, which remediates the flaw, e.g., by emulating the functionality, working around the affected component, or disabling the affected component. In addition, the error may also be reported to the manufacturer, so the manufacturer can create a formal fix to patch the CPU. In the meantime, the CPU stays online. The formal fix can be applied during a normal maintenance window, which may avoid unexpected downtime.

Thus, while, in other systems, microcode patches for fixes are issued as well, it is an offline, transactional process, which may take several months and requires taking nodes offline in the customer's server farm. The proposed concept may however allow, for on-line, real-time self-fixing. Moreover, as the industry tends towards extending the life of existing silicon (e.g., sustain fleet for longer duration), having the ability to self-heal aging processing devices may provide additional benefit to the customers. This can also be combined with existing servicing flows like seamless updates.

In addition, the proposed concept may be used to de-feature or degrade processing devices, if necessary, e.g., to disable components found to be faulty. In this case, the enhanced IFS may report the omission of that feature in CPUID (an auxiliary processor instruction exposing details and capabilities of the processor to the system firmware or operating system). This may also enable post-ship ‘binning’, since today this type of test/sort/binning only can be done during manufacturing.

To summarize, various examples of the proposed concept may relate to the following aspects: Extending the in-field scan detection to invoke a handler. For example, the handler may emulate a capability, or the handler may remove (e.g., elide) a capability and update CPUID correspondingly. Potential fix telemetry may be reported back to the manufacturer so the manufacturer can develop a robust fix. Moreover, the telemetry can be blinded somewhat or made concise for the handler generating long-term statistics/machine learning heuristics.

More details and aspects of the IFSXu concept are mentioned in connection with the proposed concept or one or more examples described above or below (e.g., FIG. 1a to 1c). The IFSXu concept may comprise one or more additional optional features corresponding to one or more aspects of the proposed concept, or one or more examples described above or below.

In the following, some examples of the proposed concept are presented:

An example (e.g., example 1) relates to an apparatus (10) for configuring a processing device (105), the apparatus comprising interface circuitry (12) and processing circuitry (14) configured to obtain information on a failure related to a component of the processing device (105), with the failure having occurred at runtime of the processing device. The processing circuitry is configured to determine information on a microcode update to be applied to the processing device to remedy the failure related to the component. The processing circuitry is configured to configure the processing device to apply the microcode update.

Another example (e.g., example 2) relates to a previously described example (e.g., example 1) or to any of the examples described herein, further comprising that the information on the failure related to the component comprise information on a circuit-level failure affecting the component.

Another example (e.g., example 3) relates to a previously described example (e.g., one of the examples 1 to 2) or to any of the examples described herein, further comprising that the information on the failure related to the component is based on a failure related to the component occurring in the field.

Another example (e.g., example 4) relates to a previously described example (e.g., one of the examples 1 to 3) or to any of the examples described herein, further comprising that the processing circuitry is configured to obtain the information on the failure related to the component of the processing device from an in-field scan circuitry of the processing device.

Another example (e.g., example 5) relates to a previously described example (e.g., one of the examples 1 to 4) or to any of the examples described herein, further comprising that the processing circuitry is configured to obtain the information on the failure related to the component after an interrupt being raised by an in-field scan circuitry of the processing device.

Another example (e.g., example 6) relates to a previously described example (e.g., one of the examples 1 to 5) or to any of the examples described herein, further comprising that the processing circuitry is configured to determine the information on the microcode update to be applied to the processing device to remedy the failure related to the component based on a mapping between failures and microcode updates.

Another example (e.g., example 7) relates to a previously described example (e.g., example 6) or to any of the examples described herein, further comprising that the processing circuitry is configured to update the mapping between the failures and microcode updates.

Another example (e.g., example 8) relates to a previously described example (e.g., one of the examples 6 to 7) or to any of the examples described herein, further comprising that the mapping is an operator-defined policy supplied by an operator of a computer system comprising the processing device.

Another example (e.g., example 9) relates to a previously described example (e.g., one of the examples 1 to 8) or to any of the examples described herein, further comprising that the processing circuitry is configured to obtain second information on a failure of a component of the processing device occurring in other computer systems, to determine information on a microcode update to be applied to the processing device to remedy the failure related to the component included in the second information, and to configure the processing device to apply the microcode update.

Another example (e.g., example 10) relates to a previously described example (e.g., example 15) or to any of the examples described herein, further comprising that the second information is operator-specified second information supplied by an operator of a computer system comprising the processing device.

Another example (e.g., example 11) relates to a previously described example (e.g., example 15) or to any of the examples described herein, further comprising that the second information is based on failures of one or more components of the processing device having occurred in a plurality of computer systems being operated by the operator.

Another example (e.g., example 12) relates to a previously described example (e.g., one of the examples 1 to 11) or to any of the examples described herein, further comprising that the microcode update affects an operating frequency of the component of the processing device.

Another example (e.g., example 13) relates to a previously described example (e.g., one of the examples 1 to 12) or to any of the examples described herein, further comprising that the microcode update affects a use of one or more components of the processing device for performing an instruction being exposed by an instruction set architecture of the processing device.

Another example (e.g., example 14) relates to a previously described example (e.g., one of the examples 1 to 13) or to any of the examples described herein, further comprising that the microcode update comprises instructions to emulate a functionality originally provided by the component.

Another example (e.g., example 15) relates to a previously described example (e.g., one of the examples 1 to 14) or to any of the examples described herein, further comprising that the microcode update affects a shared use of one or more components of the processing device in simultaneous multithreading.

Another example (e.g., example 16) relates to a previously described example (e.g., one of the examples 1 to 15) or to any of the examples described herein, further comprising that the microcode update affects the instructions being exposed by an instruction set architecture of the processing device.

Another example (e.g., example 17) relates to a previously described example (e.g., one of the examples 1 to 16) or to any of the examples described herein, further comprising that the microcode update relates to an input/output controller (107) of the processing device, affecting the use of at least a part of an interface being coupled to the processing device.

Another example (e.g., example 18) relates to a previously described example (e.g., one of the examples 1 to 17) or to any of the examples described herein, further comprising that the microcode update relates to a memory controller (108) of the processing device, affecting the use of at least a portion of memory included in a computer system comprising the processing device.

Another example (e.g., example 19) relates to a previously described example (e.g., one of the examples 1 to 18) or to any of the examples described herein, further comprising that the microcode update relates to a storage controller (109) of the processing device, affecting the use of at least a portion of storage circuitry included in a computer system comprising the processing device.

Another example (e.g., example 20) relates to a previously described example (e.g., one of the examples 1 to 11) or to any of the examples described herein, further comprising that the microcode update is configured to disable the component.

Another example (e.g., example 21) relates to a previously described example (e.g., one of the examples 1 to 20) or to any of the examples described herein, further comprising that the microcode update is a XuCode update.

Another example (e.g., example 22) relates to a previously described example (e.g., one of the examples 1 to 21) or to any of the examples described herein, further comprising that the processing device is an XPU.

Another example (e.g., example 23) relates to a previously described example (e.g., example 22) or to any of the examples described herein, further comprising that the XPU is one of a Central Processing Unit (CPU), Graphics Processing Unit (GPU), an Artificial Intelligence (AI) accelerator, an accelerator card and offloading circuitry.

An example (e.g., example 24) relates to a computer system (100) comprising the apparatus (10) according to one of the examples 1 to 23 or according to any other example and the processing device (105).

Another example (e.g., example 25) relates to a previously described example (e.g., example 24) or to any of the examples described herein, further comprising that the apparatus is implemented as part of a system firmware of the computer system.

An example (e.g., example 26) relates to an apparatus (10) for configuring a processing device (105), the apparatus comprising interface circuitry (12), machine-readable instructions and processing circuitry (14) to execute the machine-readable instructions to obtain information on a failure related to a component of the processing device (105), with the failure having occurred at runtime of the processing device. The machine-readable instructions comprise instructions to determine information on a microcode update to be applied to the processing device to remedy the failure related to the component. The machine-readable instructions comprise instructions to configure the processing device to apply the microcode update.

An example (e.g., example 27) relates to a computer system (100) comprising the apparatus (10) according to example 26 and the processing device (105).

An example (e.g., example 28) relates to a device (10) for configuring a processing device (105), the device comprising means for communicating (12) and means for processing (14) configured to obtain information on a failure related to a component of the processing device (105), with the failure having occurred at runtime of the processing device. The means for processing is configured to determine information on a microcode update to be applied to the processing device to remedy the failure related to the component. The means for processing is configured to configure the processing device to apply the microcode update.

An example (e.g., example 29) relates to a computer system (100) comprising the device (10) according to example 28 and the processing device (105).

An example (e.g., example 30) relates to a method for configuring a processing device (105), the method comprising obtaining (110) information on a failure related to a component of the processing device (105), with the failure having occurred at runtime of the processing device. The method comprises determining (130) information on a microcode update to be applied to the processing device to remedy the failure related to the component. The method comprises configuring (140) the processing device to apply the microcode update.

Another example (e.g., example 31) relates to a previously described example (e.g., example 30) or to any of the examples described herein, further comprising that the method comprises obtaining (110) the information on the failure related to the component of the processing device from an in-field scan circuitry of the processing device.

Another example (e.g., example 32) relates to a previously described example (e.g., one of the examples 30 to 31) or to any of the examples described herein, further comprising that the method comprises obtaining (110) the information on the failure related to the component after an interrupt being raised by an in-field scan circuitry of the processing device.

Another example (e.g., example 33) relates to a previously described example (e.g., one of the examples 30 to 32) or to any of the examples described herein, further comprising that the method comprises determining (130) the information on the microcode update to be applied to the processing device to remedy the failure related to the component based on a mapping between failures and microcode updates.

Another example (e.g., example 34) relates to a previously described example (e.g., example 33) or to any of the examples described herein, further comprising that the method comprises updating (135) the mapping between the failures and microcode updates.

Another example (e.g., example 35) relates to a previously described example (e.g., one of the examples 30 to 34) or to any of the examples described herein, further comprising that the method comprises obtaining (120) second information on a failure of a component of the processing device occurring in other computer systems, determining (130) information on a microcode update to be applied to the processing device to remedy the failure related to the component included in the second information, and configuring (140) the processing device to apply the microcode update.

An example (e.g., example 36) relates to a computer system (100) being configured to perform the method according to one of the examples 30 to 35 or according to any other example, the computer system comprising the processing device (105).

Another example (e.g., example 37) relates to a previously described example (e.g., example 36) or to any of the examples described herein, further comprising that the method is performed by a system firmware of the computer system.

An example (e.g., example 38) relates to a non-transitory machine-readable storage medium including program code, when executed, to cause a machine to perform the method of one of the examples 30 to 35 or according to any other example.

An example (e.g., example 39) relates to a computer program having a program code for performing the method of one of the examples the method of one of the examples 30 to 35 or according to any other example when the computer program is executed on a computer, a processor, or a programmable hardware component.

An example (e.g., example 40) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for configuring a processing device, the apparatus comprising interface circuitry, machine-readable instructions, and processing circuitry to execute the machine-readable instructions to:
obtain information on a failure related to a component of the processing device, with the failure having occurred at runtime of the processing device;
determine information on a microcode update to be applied to the processing device to remedy the failure related to the component; and
configure the processing device to apply the microcode update.

2. The apparatus according to claim 1, wherein the information on the failure related to the component comprise information on a circuit-level failure affecting the component.

3. The apparatus according to claim 1, wherein the information on the failure related to the component is based on a failure related to the component occurring in the field.

4. The apparatus according to claim 1, wherein the machine-readable instructions comprise instructions to obtain the information on the failure related to the component of the processing device from an in-field scan circuitry of the processing device.

5. The apparatus according to claim 1, wherein the machine-readable instructions comprise instructions to obtain the information on the failure related to the component after an interrupt being raised by an in-field scan circuitry of the processing device.

6. The apparatus according to claim 1, wherein the machine-readable instructions comprise instructions to determine the information on the microcode update to be applied to the processing device to remedy the failure related to the component based on a mapping between failures and microcode updates.

7. The apparatus according to claim 6, wherein the machine-readable instructions comprise instructions to update the mapping between the failures and microcode updates.

8. The apparatus according to claim 6, wherein the mapping is an operator-defined policy supplied by an operator of a computer system comprising the processing device.

9. The apparatus according to claim 1, wherein the machine-readable instructions comprise instructions to obtain second information on a failure of a component of the processing device occurring in other computer systems, to determine information on a microcode update to be applied to the processing device to remedy the failure related to the component included in the second information, and to configure the processing device to apply the microcode update.

10. The apparatus according to claim 15, wherein the second information is operator-specified second information supplied by an operator of a computer system comprising the processing device.

11. The apparatus according to claim 15, wherein the second information is based on failures of one or more components of the processing device having occurred in a plurality of computer systems being operated by the operator.

12. The apparatus according to claim 1, wherein the microcode update affects an operating frequency of the component of the processing device.

13. The apparatus according to claim 1, wherein the microcode update affects a use of one or more components of the processing device for performing an instruction being exposed by an instruction set architecture of the processing device.

14. The apparatus according to claim 1, wherein the microcode update comprises instructions to emulate a functionality originally provided by the component.

15. The apparatus according to claim 1, wherein the microcode update affects a shared use of one or more components of the processing device in simultaneous multithreading.

16. The apparatus according to claim 1, wherein the microcode update affects the instructions being exposed by an instruction set architecture of the processing device.

17. The apparatus according to claim 1, wherein the microcode update relates to an input/output controller of the processing device, affecting the use of at least a part of an interface being coupled to the processing device.

18. The apparatus according to claim 1, wherein the microcode update relates to a memory controller of the processing device, affecting the use of at least a portion of memory included in a computer system comprising the processing device.

19. The apparatus according to claim 1, wherein the microcode update relates to a storage controller of the processing device, affecting the use of at least a portion of storage circuitry included in a computer system comprising the processing device.

20. The apparatus according to claim 1, wherein the microcode update is configured to disable the component.

21. The apparatus according to claim 1, wherein the processing device is an XPU, the XPU being one of a Central Processing Unit (CPU), Graphics Processing Unit (GPU), an Artificial Intelligence (AI) accelerator, an accelerator card and offloading circuitry.

22. A computer system comprising the apparatus according to claim 1 and the processing device.

23. The computer system according to claim 22, wherein the apparatus is implemented as part of a system firmware of the computer system.

24. A method for configuring a processing device, the method comprising:
obtaining information on a failure related to a component of the processing device, with the failure having occurred at runtime of the processing device;
determining information on a microcode update to be applied to the processing device to remedy the failure related to the component; and
configuring the processing device to apply the microcode update.

25. A non-transitory machine-readable storage medium including program code, when executed, to cause a machine to perform the method of claim 24.
